(19) United States
(12) Patent Application Publication
(10) Pub. No.: US 2010/0069528 A1
(43) Pub. Date: Mar. 18, 2010

(54) BIODEGRADABLE TOYS

(76) Inventors: Gregory Trimarche, Laguna Beach, CA (US); Melissa Trimarche, Laguna Beach, CA (US)

Correspondence Address: GREENBERG TRAURIG LLP (LA), 2450 COLORADO AVENUE, SUITE 400E, INTELLECTUAL PROPERTY DEPARTMENT, SANTA MONICA, CA, 90404, US

(21) Appl. No.: 12/209,476

(22) Filed: Sep. 12, 2008

(51) Int. Cl. C08K 11/00

(52) U.S. Cl. 523/128

(57) ABSTRACT

Disposable beach friendly accessories, picnic-ware, cutlery, toys and related accoutrements for children formed from a biodegradable material are provided. The disposable beach friendly accessories, picnic-ware, cutlery, toys and related accoutrements for children may include an inner core formed from a biodegradable material, an outer layer covering the inner core, and activation means for exposing the inner core for degradation. The biodegradable material may decompose or disintegrate within about 48 hours from contact with water.

### RELATED APPLICATION

This application claims the benefit of and priority to U.S. Provisional Application Ser. No. 60/013,935, filed Dec. 14, 2007, U.S. Provisional Application Ser. No. 60/915,299, filed May 1, 2007, and U.S. Utility patent application Ser. No. 12/113,820, filed May 1, 2008, the contents of each of which are incorporated by reference herein in its entirety.

### BACKGROUND

This disclosure relates generally to beach friendly accessories, picnic-ware, cutlery, toys and related accoutrements for children. The disclosure more specifically relates to biodegradable toys and related accessories.

### SUMMARY

A disposable, single-use type article, for example, a toy or cutlery formed from a biodegradable material is disclosed. The biodegradable material may be an environmentally safe composite, a pulverized animal-by-product, a pulverized fish-by-product, a cellulose derived material, a starch-based polymer, and the like. In one embodiment, the disposable, single-use type article may include an outer layer for protecting the biodegradable material, the outer layer may be a corn starch adhesive for providing exterior strength and firmness to the biodegradable material. The outer layer may also be a non-biodegradable material comprising an activation means for exposing the biodegradable material. The activation means may include a press fit connection or a screw connection between segments of the disposable, single-use type article, a peelable tab on at least one surface of the disposable, single-use type article, and a removable end plug on the disposable, single-use type article.

In another embodiment, a substantially biodegradable toy is provided. The substantially biodegradable toy may include an inner core formed from a biodegradable material, an outer layer covering the inner core, and activation means for exposing the inner core for degradation. In yet another embodiment, a disposable beach toy formed from a biodegradable material is provided. The biodegradable material may decompose or disintegrate within about 48 hours from contact with water.

### DRAWINGS

The above-mentioned features and objects of the present disclosure will become more apparent with reference to the following description taken in conjunction with the accompanying drawings wherein like reference numerals denote like elements and in which:

FIG. 1 illustrates a biodegradable figurine, according to embodiments of the present invention.

FIG. 2 Illustrates biodegradable beach toys, according to embodiments of the present invention.

FIG. 3 Illustrates biodegradable cutlery, according to embodiments of the present invention.

### DETAILED DESCRIPTION

In the description that follows, the present disclosure will be described in reference to a preferred embodiment that utilizes a biodegradable material for beach friendly accessories, picnic-ware, cutlery, figurines, toys and related accoutrements for children (collectively referred to herein as “toys” and/or “articles”). The present disclosure, however, is not limited to any particular application nor is it limited by the examples described herein. Therefore, the description of the embodiments that follow are for purposes of illustration and not limitation.

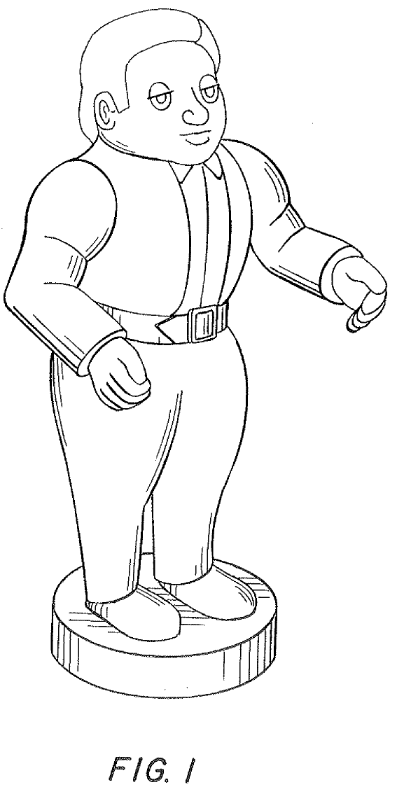

When articles, as shown in FIGS. 1-3, are disposed in landfills, they may decay over several years, and many remain in essentially unaltered form for generations. According to one embodiment of the present invention, these articles may be fabricated from biodegradable or substantially biodegradable material(s).

The term “biodegradable,” as used herein, means subject to chemical degradation, usually oxidation, by exposure to biological or environmental conditions. The term includes degradation by exposure to ultraviolet light, sunlight, fluids, temperatures and pressures normally found in landfills, bacteria (both aerobic and anaerobic) and any other condition found in the biosphere.

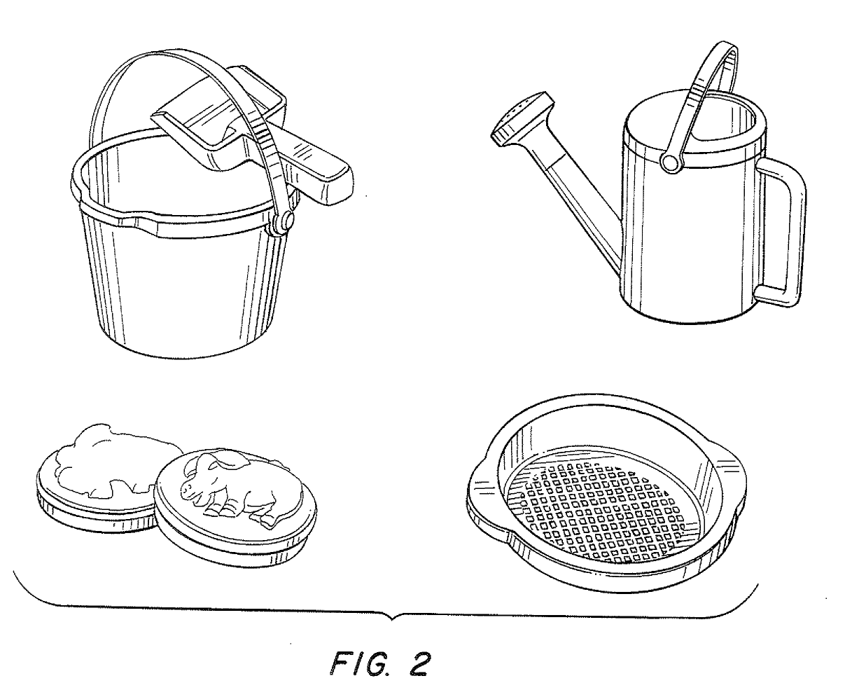

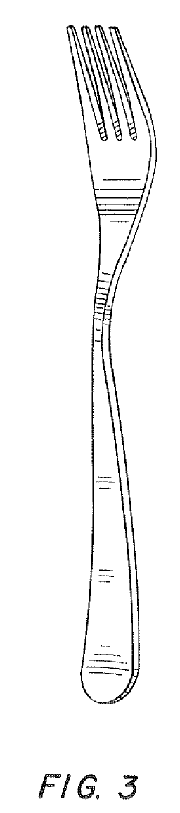

In one embodiment, the articles may be fabricated from a biodegradable material that decomposes or disintegrates within about 48 hours once in contact with water. As such, the articles may be implemented in a single use article, for example, biodegradable beach toys or cutlery, as shown in FIGS. 2-3. In another embodiment, the articles may be fabricated of a substantially biodegradable material having a biodegradable inner layer or core, an outer layer that resists degradation, and an activation means coupled to the outer layer that, when activated, exposes the biodegradable inner layer or core to the environment.

The biodegradable material may be environmentally safe composites of rendered by-products from animal groups. Animal by-product may be used as the raw material for fabricating the biodegradable article. Fish by-product, such as skin, scales, bone, soft tissue and/or organs may also be used as the raw material for fabricating the biodegradable article. The raw material may also be made from cellulose derived materials or starch based biodegradable materials.

In one embodiment, the raw material may be crushed and placed in a cooker for a predetermined temperature to remove excess fats, tumbled dried and then ground to very fine powder. The powder may then molded and pressed to the shape of the biodegradable article, such as a toy or figurine. An adhesive, such as a corn starch adhesive, may be applied on the biodegradable article to add exterior strength and firmness. As can be appreciated, the biodegradable article may decompose or disintegrate within about 48 hours once in contact with water. As such, the biodegradable article may be implemented in a disposable single-use type article, for example, a biodegradable beach toy. The biodegradable beach toy may be sold for vacationers, much like the single use cameras. The biodegradable beach toy, if left on the beach, will disintegrate within about 48 hours once in contact with the water, for example, for the sea, ocean, lake or river.

In one embodiment, biodegradable polymers may be used as the raw material for fabricating the biodegradable article. For example, biodegradable polymer, such as NOVON brand, a starch-based polymer described in U.S. Pat. No. 4,673,438 and U.S. Pat. No. 4,738,724, incorporated herein by reference. Shaped biodegradable beach friendly accessories, picnic-ware, cutlery, toys and related accoutrements for children made from such a material may be broken down in landfills.

In one embodiment, the articles may be fabricated of a substantially biodegradable material having a biodegradable inner layer or core, an outer layer that resists degradation, and an activation means coupled to the outer layer that, when activated, exposes the biodegradable inner layer or core to the environment. The outer layer may be biodegradable, but preferably less so than the inner core. If the outer layer is made of a non-biodegradable material, such as polyurethane, the thickness of the outer layer is preferably small enough to provide protection to the inner core, for example, 0.1% of the article's overall thickness. The outer layer may be applied to the inner layer or core by co-molding, co-extrusion, spraying, painting, dipping, shrink wrapping and/or dripping.

The activation means may be used to expose the inner core for degradation and/or disintegration. In one embodiment, the activation means may include a press fit connection, a screw connection, a peelable tab on at least one surface of the article, or a removable end plug on the article, which all when removed, exposes the inner core for degradation and/or disintegration. In another embodiment, the activation means may include a biodegradable material, less so than the inner core, and covering an opening in the outer layer that exposes the inner core. As such, the article may be designed to have a useful life of a predetermined period or predetermined number of uses. For example, the activation means may be a biodegradable material that disintegrates after exposure to water for a week. The activation means, if incorporated in a beach toy, may allow the beach toy to have a useful life of a little over a week, after the inner core disintegrates as well. In yet another embodiment, the activation means may include a fault, such as a V-notch, groove or indentation in the outer layer to allow breakage of the outer layer by manual pressure exerted by the user so as to expose the inner layer or core for degradation or disintegration.

The skilled artisan will be aware of other available environmentally safe materials, all of which are encompassed by the present disclosure.

While the biodegradable beach friendly accessories, picnic-ware, cutlery, toys and related accoutrements for children have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

It should also be understood that a variety of changes may be made without departing from the essence of the invention. Such changes are also implicitly included in the description. They still fall within the scope of this invention. It should be understood that this disclosure is intended to yield a patent covering numerous aspects of the invention both independently and as an overall system and in both method and apparatus modes.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these.

Particularly, it should be understood that as the disclosure relates to elements of the invention, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this invention is entitled.

It should be understood that all actions may be expressed as a means for taking that action or as an element which causes that action.

Similarly, each physical element disclosed should be understood to encompass a disclosure of the action which that physical element facilitates.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in at least one of a standard technical dictionary recognized by artisans and the Random House Webster's Unabridged Dictionary, latest edition are hereby incorporated by reference.

Finally, all referenced listed in the Information Disclosure Statement or other information statement filed with the application are hereby appended and hereby incorporated by reference; however, as to each of the above, to the extent that such information or statements incorporated by reference might be considered inconsistent with the patenting of this/these invention(s), such statements are expressly not to be considered as made by the applicant(s).

In this regard it should be understood that for practical reasons and so as to avoid adding potentially hundreds of claims, the applicant has presented claims with initial dependencies only.

Support should be understood to exist to the degree required under new matter laws—including but not limited to United States Patent Law 35 USC 132 or other such laws—to permit the addition of any of the various dependencies or other elements presented under one independent claim or concept as dependencies or elements under any other independent claim or concept.

To the extent that insubstantial substitutes are made, to the extent that the applicant did not in fact draft any claim so as to literally encompass any particular embodiment, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative embodiments.

Further, the use of the transitional phrase “comprising” is used to maintain the “open-end” claims herein, according to traditional claim interpretation. Thus, unless the context requires otherwise, it should be understood that the term “compromise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A disposable, single-use type article in the form of at least one shape selected from the group of beach accessories consisting of picnic-ware, cutlery and toys for beach-based recreational activities formed from a biodegradable material.

2. The disposable, single-use type article of claim 1, wherein the biodegradable material is at least one material selected from the group consisting of an environmentally safe composite, a pulverized animal-by-product, a pulverized fish-by-product, a cellulose derived material, and a starch-based polymer.

3. The disposable, single-use type article of claim 2, being formed in the shape of an article of cutlery.

4. The disposable, single-use type article of claim 2, wherein the pulverized fish-by-product is selected from the group consisting of fish skin, fish scales, fish bone, fish soft tissue and fish organs.

5. The disposable, single-use type article of claim 1, wherein the biodegradable material is molded into a shape of a toy.

6. The disposable, single- use type article of claim 1, further comprising an outer layer for protecting the biodegradable material.

7. The disposable, single-use type article of claim 6, wherein the outer layer is a corn starch adhesive for providing exterior strength and firmness to the biodegradable material.

8. The disposable, single-use type article of claim 6, wherein the outer layer is a non-biodegradable material comprising an activation means for exposing the biodegradable material, wherein the activation means is selected from a group consisting of a press fit connection or a screw connection between segments of the disposable, single-use type article, a peelable tab on at least one surface of the disposable, single-use type article, and a removable end plug on the disposable. single-use type article.

9. The disposable, single-use type article of claim 8, wherein the activation means is selected from a group consisting of a press fit connection or a screw connection between segments of the disposable, single-use type article, a peelable tab on at least one surface of the disposable, single-use type article, and a removable end plug on the disposable, single-use type article.

10. A substantially biodegradable article for beach-based recreational activities, comprising:
an inner core formed from a biodegradable material;
an outer layer covering the inner core; and
activation means for exposing the inner core for degradation selected from a group consisting of a press fit connection or a screw connection between segments of the disposable, single-use type article, a peelable tab on at least one surface of the disposable, single-use type article, and a removable end plug on the disposable, single-use type article.

11. The substantially biodegradable article of claim 10, wherein the outer layer is formed from a biodegradable material more resistant to environmental conditions causing degradation than the biodegradable material of the inner core.

12. The substantially biodegradable article of claim 10, wherein the biodegradable material of the inner core is made from pulverized material selected from a group consisting of animal by-product, fish by-product, and cellulose derived material.

13. The substantially biodegradable article of claim 10, wherein the biodegradable material of the inner core biodegrade within 48 hours of contact with water.

14. The substantially biodegradable article of claim 10, wherein the biodegradable material is a starch-based polymer.

15. The substantially biodegradable article of claim 10, wherein the activation means is selected from a group consisting of a press fit connection or a screw connection between segments of the disposable, single-use type toy, a peelable tab on at least one surface of the disposable, single-use type toy, and a removable end plug on the disposable, single-use type toy.

16. A disposable article especially useful for beach-based recreational activities formed from a biodegradable material, said biodegradable material decomposes or disintegrates within about 48 hours from contact with water.

17. The disposable article of claim 16, wherein the biodegradable material of the inner core is made from pulverized material selected from a group consisting of animal by-product and fish by-product.

18. The disposable article of claim 16, further comprising an outer covering formed a corn starch adhesive for providing exterior strength and firmness to the biodegradable material.

19. The disposable article of claim 16, wherein the biodegradable material is molded into a shape of an article of cutlery.

20. The disposable article of claim 16, wherein the biodegradable material is molded into a shape of a toy.
